(19) United States
(12) Patent Application Publication
(10) Pub. No.: US 2026/0171429 A1
(43) Pub. Date: Jun. 18, 2026

(54) CATALYST FOR ELECTROCHEMICAL CELL AND MEMBRANE-ELECTRODE ASSEMBLY

(71) Applicant: SAMSUNG ELECTRO-MECHANICS CO., LTD., Suwon-si (KR)

(72) Inventors: Guh Hwan LIM, Suwon-si (KR); Byung Chul JANG, Suwon-si (KR); Dong In JEONG, Suwon-si (KR); Hae Sol JUNG, Suwon-si (KR); Sun Il JEONG, Suwon-si (KR); Tae Jun CHOI, Suwon-si (KR)

(73) Assignee: SAMSUNG ELECTRO-MECHANICS CO., LTD., Suwon-si (KR)

(21) Appl. No.: 19/338,132

(22) Filed: Sep. 24, 2025

(30) Foreign Application Priority Data
Dec. 12, 2024 (KR) 10-2024-0184773

(51) Int. Cl. H01M 4/90; H01M 4/86; H01M 8/1004; H01M 8/1048

(52) U.S. Cl. CPC H01M 4/9016; H01M 4/8605; H01M 4/9075; H01M 8/1004; H01M 8/1048

(57) ABSTRACT

A catalyst for an electrochemical cell includes a support particle and a catalyst portion formed on a surface of the support particle and including an aggregate of Ir oxide particles, wherein a portion of the surface of the support particle may be an exposed region not covered with the catalyst portion.

### CROSS-REFERENCE TO RELATED APPLICATION(S)

This application claims benefit of priority to Korean Patent Application No. 10-2024-0184773 filed on Dec. 12, 2024 in the Korean Intellectual Property Office, the disclosure of which is incorporated herein by reference in its entirety.

### TECHNICAL FIELD

The present disclosure relates to a catalyst for an electrochemical cell and a membrane-electrode assembly.

Polymer electrolyte membrane fuel cells and polymer electrolyte membrane water electrolysis cells, eco-friendly energy source devices using hydrogen, which are highly efficient and available for miniaturization, have come to prominence. Polymer electrolyte membrane fuel cells and polymer electrolyte membrane water electrolysis cells generally include a membrane-electrode assembly (MEA) in which a polymer electrolyte membrane is disposed between catalyst electrodes, and the performance of the membrane-electrode assembly significantly affects the performance of the fuel cells or water electrolysis cells.

Such a membrane-electrode assembly may generally be manufactured by a method of forming a catalyst electrode on both sides of a polymer electrolyte membrane, and here, the catalyst electrode may include a catalyst and a support, supporting the catalyst. In order to improve the efficiency of a fuel cell or water electrolysis cell, the reaction efficiency has to be improved within the catalyst electrode, and design methods for the catalyst electrode to have high efficiency have been studied in the art.

### SUMMARY

An aspect of the present disclosure is to provide a membrane-electrode assembly having a catalyst electrode having high reaction efficiency.

However, the purpose of the present disclosure is not limited to the aforementioned purpose and includes technical problems that may be realized by means and combinations thereof described in the claims.

According to an aspect of the present disclosure, a catalyst for an electrochemical cell includes: a support particle; and a catalyst portion formed on a surface of the support particle and including an aggregate of Ir oxide particles, wherein a portion of the surface of the support particle may be an exposed region not covered with the catalyst portion.

The support particle may include a Ti oxide.

A diameter of the support particles may be 50 nm or more and 100 nm or less.

The catalyst portion may be in a form of a plurality of Ir oxide particles stacked in the aggregate based on a direction, perpendicular to the surface of the support particle.

The Ir oxide particle may further include Ru.

A molar ratio of Ir to Ru in the Ir oxide particle may be 5% to 95%.

A ratio of the exposed region on the surface of the support particle may be 10% to 50% with respect to a total surface of the support particle.

A diameter of the Ir oxide particle may be 1 nm to 10 nm.

The catalyst portion may further include an Ru oxide particle.

The Ir oxide particle and the Ru oxide particle may be randomly mixed.

The Ir oxide particle and the Ru oxide particle may each be formed in a layer structure and are separated from each other.

The Ru oxide particle may be disposed closer to the support particle than the Ir oxide particle.

According to another aspect of the present disclosure, a membrane-electrode assembly includes: first and second catalyst electrodes; and a polymer electrolyte membrane disposed between the first and second catalyst electrodes, wherein the first catalyst electrode may include a support particle and a catalyst portion formed on a surface of the support particle and including an aggregate of Ir oxide particles, and a portion of the surface of the support particle may be an exposed region not covered with the catalyst portion.

The first catalyst electrode may include a plurality of the support particles, and among the plurality of support particles, the catalyst portions of adjacent support particles may be connected to each other.

The first catalyst electrode may include a pore formed by the exposed region.

The first catalyst electrode may include a pore formed by the catalyst portions connected to each other.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a cross-sectional view schematically illustrating a catalyst for an electrochemical cell according to an embodiment of the present disclosure;

FIG. 2 is a cross-sectional view schematically illustrating a catalyst portion that may be included in a catalyst for an electrochemical cell;

FIG. 3 is a cross-sectional view schematically illustrating a catalyst for an electrochemical cell according to another embodiment;

FIG. 4 is a cross-sectional view schematically illustrating a catalyst for an electrochemical cell according to another embodiment;

FIG. 5 is an exploded perspective view schematically illustrating a membrane-electrode assembly according to an embodiment of the present disclosure;

FIG. 6 is a cross-sectional view of one area of a membrane-electrode assembly; and

FIG. 7 is an enlarged view of a region of a first catalyst electrode.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising”, will be understood to imply the inclusion of stated elements but not the exclusion of any other elements.

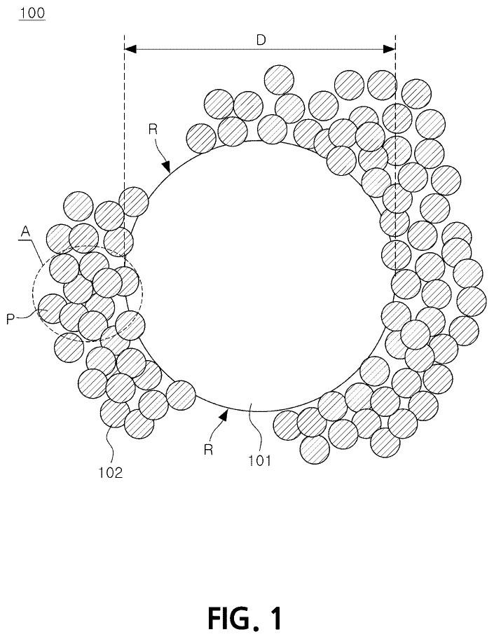

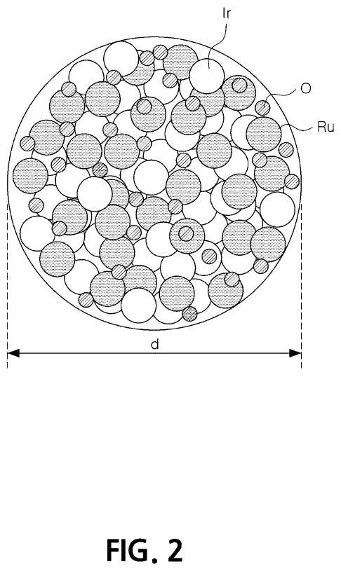

FIG. 1 is a cross-sectional view schematically illustrating a catalyst for an electrochemical cell according to an embodiment of the present disclosure. FIG. 2 is a cross-sectional view schematically illustrating a catalyst portion that may be included in a catalyst for an electrochemical cell.

Referring to FIGS. 1 and 2, a catalyst 100 for an electrochemical cell according to an embodiment of the present disclosure may include a support particle 101 and a catalyst portion 102 formed on a surface of the support particle 101, and here, a portion of the surface of the support particle 101 may be not covered with the catalyst portion 102 and may include an exposed region R. The catalyst portion 102 may include an aggregate A of Ir oxide particles P. In the case of the present embodiment, an Ir oxide having a catalytic function may be used in the form of particles P supported by the support particle 101, so that the usage amount of the Ir oxide particles P may be reduced while effectively forming the Ir oxide particles P. In addition, by forming a portion of the surface of the support particle 101 as the exposed region R not covered with the Ir oxide particles P, a flow of fluid may become smooth, while an electrical connection path is maintained when used as a catalyst electrode. Hereinafter, the main components of the catalyst 100 for an electrochemical cell will be described.

The support particle 101 may support the catalyst portion 102. Since the support particle 101 have a high surface area on which a catalyst material may be formed, the support particle 101 may function to maintain a high catalytic activity of a catalyst electrode even without significantly increasing the amount of the catalyst material. Considering such a function, the support particle 101 may include an antimony tin oxide (ATO), an indium tin oxide (ITO), a fluorine doped tin oxide (FTO), TiO₂, Ti₂O₃, Ti₃O₅, Ti₄O₇, CeO₂, carbon black, carbon nanotube (CNT), graphene flake, graphene oxide (GO), or reduced graphene oxide (RGO), etc. As a representative example thereof, the support particle 101 may include a Ti oxide.

A size of the support particle 101 is not particularly limited as long as it is suitable for use as a catalyst electrode, and for example, a diameter D of the support particle 101 may be 50 nm or more and 100 nm or less. The diameter D of the support particle 101 may be obtained by analyzing a cross-section of the catalyst 100 for an electrochemical cell. In this case, diameters D of cross-sections of a plurality of regions of the support particle 101 may be obtained and an average value thereof may be used or, and further, an average value of the diameters D obtained for a plurality of support particles 101 may be used. In addition, if the cross-section of the support particle 101 is not spherical, an equivalent diameter converted to the diameter of a circle having the corresponding area may also be used.

The catalyst portion 102 may be formed on the surface of the support particle 101 and may include an Ir oxide as being active in an oxygen generation reaction. To this end, the catalyst portion 102 may include the Ir oxide particles P, and specifically, the aggregate A obtained by agglomeration of the Ir oxide particles P may be formed on the surface of the support particle 101. In this case, as illustrated, the catalyst portion 102 may be in the form of a plurality of Ir oxide particles P stacked in the aggregate A based on a direction, perpendicular to the surface of the support particle 101, and the amount of the catalyst may be effectively controlled through the Ir oxide particle P multilayer structure.

The Ir oxide particle P of the catalyst portion 102 may be IrOₓ, but may further include Ru depending on an embodiment. That is, as illustrated in FIG. 2, the Ir oxide particle P of the catalyst portion 102 may include IrRuOₓ, which is a composite oxide including Ir and Ru. Here, a molar ratio of Ir to Ru in the Ir oxide particle P may be 5% to 95%. In this case, when the Ir oxide, a catalyst material, is formed as the aggregate A of particles P, the catalyst portion 102 may be implemented as a porous structure, and in this case, the surface area of the catalyst portion 102 may increase, so that the catalytic reactivity may be improved. In addition, since the flow of fluid may be made smooth through the porous structure of the catalyst portion 102, it may contribute to improving the efficiency of the electrochemical cell.

In addition, as described above, a portion of the surface of the support particle 101 may include an exposed region R which is not covered with the catalyst portion 102. Since the exposed region R not covered with the catalyst portion 102 exists on the surface of the support particle 101, the flow of fluid may be made smooth, while the electrical connection path is maintained within the catalyst electrode. Considering these effects and the catalytic function of the catalyst portion 102, the ratio of the exposed region R in the support particle 101 may be adjusted. As a specific example, the ratio of the exposed region R on the surface of the support particle 101 may be 10% to 50% with respect to a total surface area of the support particle 101, and here, the ratio may refer to an area ratio. Similar to the diameter of the support particle 101, the ratio of the exposed region R may be obtained by analyzing a cross-section of the catalyst 100 for an electrochemical cell. In this case, length ratios of the exposed regions R in the cross-sections of a plurality of regions of the support particle 101 may be obtained and then an average value thereof may be used, and further, an average value of the length ratios of the exposed regions R obtained for a plurality of support particles 101 may be used.

Referring to FIG. 2, a diameter d of the Ir oxide particle P included in the aggregate A may be 1 nm to 10 nm. Similar to the diameter of the support particle 101, the diameter d of the Ir oxide particle P may be obtained by analyzing a cross-section of the catalyst 100 for an electrochemical cell. In this case, the diameters d obtained from the cross-sections of a plurality of regions of the Ir oxide particles P may be obtained and an average value thereof may be used, and further, an average value of the diameters d obtained for a plurality of Ir oxide particles P may be used. In addition, if the cross-section of the Ir oxide particle P is not spherical, an equivalent diameter converted to the diameter of a circle having the corresponding area may also be used.

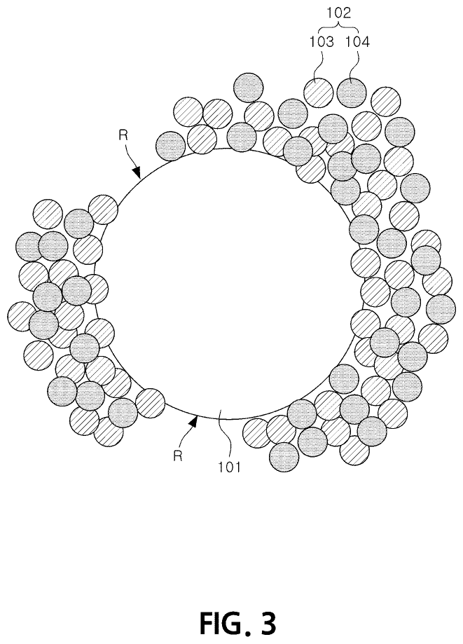

As in the embodiment of FIG. 3, the catalyst portion 102 may further include an Ru oxide particle 104. Specifically, the catalyst portion 102 may include an Ir oxide particle 103 and the Ru oxide particle 104, and here, unlike the preceding embodiment, the Ir oxide particle 103 may not include Ru. In this case, the Ir oxide particle 103 and the Ru oxide particle 104 may be randomly mixed. The catalyst portion 102 may be used in a form in which Ir oxide particles 103 and Ru oxide particles 104 are mixed to form an aggregate, but this may also correspond to an intermediate stage for implementing the catalyst portion of the preceding embodiment. That is, as in the embodiment of FIG. 3, the Ir oxide particles 103 and Ru oxide particles 104 may be mixed and heat-treated to form IrRuOₓ, from which the catalyst portion 102 of the embodiment of FIG. 1 may be obtained. Here, the heat treatment process may be performed at, for example, 200° C. or higher for 30 minutes or longer. In this modified example as well, a portion of the surface of the support particle 101 may be the exposed region R not covered with the catalyst portion 102.

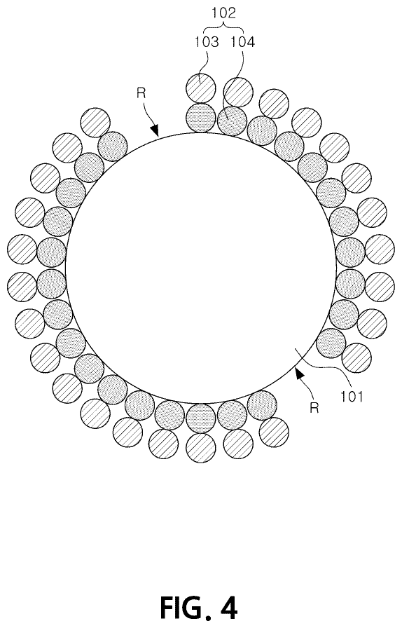

In a case in which the catalyst portion 102 includes the Ru oxide particle 104, a modified form of FIG. 4 may be also possible. Referring to FIG. 4, the Ir oxide particle 103 and the Ru oxide particle 104 may be formed in a layer structure and may be separated from each other. In this case, the Ru oxide particle 104 may be disposed closer to the support particle 101 than the Ir oxide particle 103. In this modified example as well, a portion of the surface of the support particles 101 may be the exposed region R not covered with the catalyst portion 102.

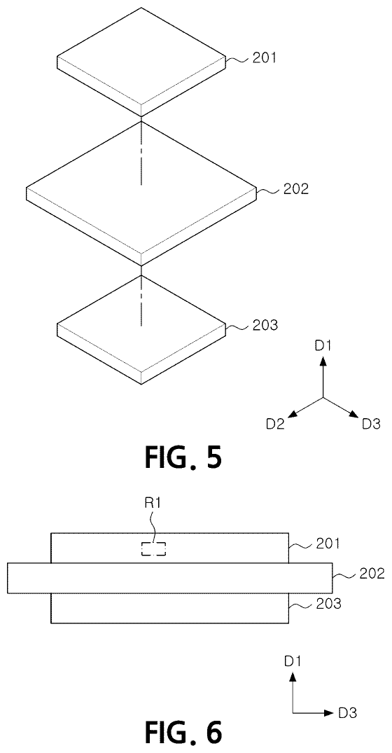

Hereinafter, a membrane-electrode assembly 200 according to another aspect of the present disclosure will be described with reference to FIGS. 5 to 7. First, as shown in the form of FIGS. 5 and 6, the membrane-electrode assembly 200 may include a first catalyst electrode 201, a polymer electrolyte membrane 202, and a second catalyst electrode 203 as main components, and the polymer electrolyte membrane 202 is disposed between the first and second catalyst electrodes 201 and 203. Here, the first catalyst electrode 201 includes the catalyst 100 for an electrochemical cell described above, and hereinafter, any redundant description of the catalyst 100 may be omitted.

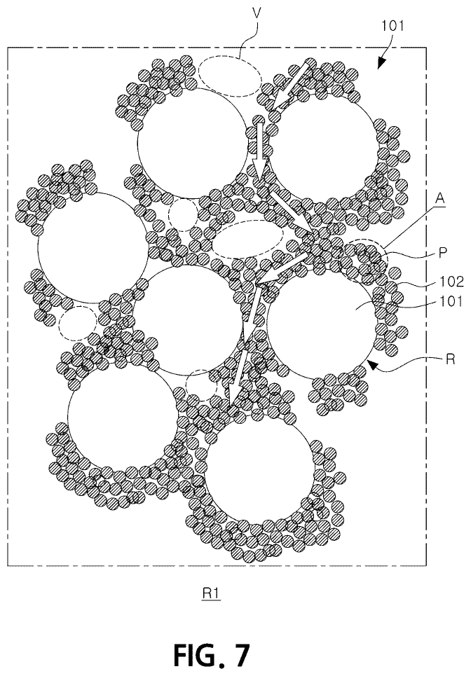

Referring to FIG. 7, the first catalyst electrode 201 may include the catalyst 100 for an electrochemical cell, and as described above, in the catalyst 100 for an electrochemical cell, a portion of the surface of the support particle 101 is the exposed region R not covered with the catalyst portion 102, and the catalyst portion 102 includes the aggregate A of Ir oxide particles P. By forming a portion of the surface of the support particle 101 as the exposed region R not covered with the Ir oxide particles P, the flow of fluid may become smooth, while an electrical connection path (the arrow) may be maintained within the first catalyst electrode 201. As a specific example, the first catalyst electrode 201 includes a plurality of support particles 101, and among the plurality of support particles 101, catalyst portions 102 of adjacent support particles 101 may be connected to each other. In other words, the adjacent support particles 101 may share the catalyst portion 102 with each other. In this case, the first catalyst electrode 201 may include a pore V formed by the exposed region R, and as described above, the pore V may become a fluid passage of fluid. However, the pore V is not formed only by the exposed region R, and the first catalyst electrode 101 may also include a pore formed by the catalyst portions 102 connected to each other.

Meanwhile, in addition to the catalyst 100 for an electrochemical cell, an ion conductor may be provided in the first catalyst electrode 201. The ion conductor may provide a movement path for hydrogen ions or the like generated in the first catalyst electrode 201, and may include, for example, a fluorine-based ionomer, a carbon-hydrogen-based ionomer, and a mixture thereof. The ion conductor may include a perfluorinated sulfonic acid ionomer.

Meanwhile, when the membrane-electrode assembly 200 is used as a water electrolysis cell, the first catalyst electrode 201 may be an anode, and water supplied thereto may be separated into oxygen O₂, hydrogen ions (H⁺, protons), and electrons. Here, the hydrogen ions may move to the second catalyst electrode 203 through the polymer electrolyte membrane 202, and the electrons may move to the second catalyst electrode 203 through an external circuit and a power supply.

The polymer electrolyte membrane 202 may include an ion conductor to provide a movement path for hydrogen ions or the like. Here, the ion conductor of the polymer electrolyte membrane 202 may include, for example, a fluorine-based ionomer, a carbon-hydrogen-based ionomer, and a mixture thereof. As a specific example, the ion conductor may include a perfluorinated sulfonic acid ionomer. When the membrane-electrode assembly 200 is used as a water electrolysis cell, hydrogen ions generated in the first catalyst electrode 201 may move to the second catalyst electrode 203 through the polymer electrolyte membrane 202.

The second catalyst electrode 203 may include a catalyst material, and the catalyst material of the second catalyst electrode 203 may be provided in a form supported on a support similar to the first catalyst electrode 201. Here, the support of the second catalyst electrode 203 may include a carbon-based support. In addition, the second catalyst electrode 203 may include an ion conductor in addition to the catalyst material. The catalyst material of the second catalyst electrode 203 may include at least one of Pt-based, Au-based, Ru-based, Os-based, and Pd-based materials, which is active in hydrogen oxidation reaction or oxygen reduction reaction. In the case of a water electrolysis cell, the second catalyst electrode 203 may be a cathode, and hydrogen ions supplied through the polymer electrolyte membrane 202 may react with electrons to generate hydrogen.

Meanwhile, in the above, the case in which the first catalyst electrode 201 and the second catalyst electrode 203 are an anode and a cathode, respectively, is given as an example, but the opposite structure is also possible. That is, as a modified example, in the membrane-electrode assembly 100, the first catalyst electrode 201 may be a cathode, and the second catalyst electrode 203 may be an anode.

The membrane-electrode assembly according to an example of the present disclosure includes the catalyst electrode having high reaction efficiency, and thus, when such a membrane-electrode assembly is used as a fuel cell or a water electrolysis cell, the performance may be improved.

While embodiments have been shown and described above, it will be apparent to those skilled in the art that modifications and variations could be made without departing from the scope of the present disclosure as defined by the appended claims.

What is claimed is:

1. A catalyst for an electrochemical cell, the catalyst comprising:
a support particle; and
a catalyst portion formed on a surface of the support particle and including an aggregate of Ir oxide particles,
wherein a portion of the surface of the support particle includes an exposed region not covered with the catalyst portion.

2. The catalyst of claim 1, wherein the support particle includes a Ti oxide.

3. The catalyst of claim 1, wherein a diameter of the support particles is 50 nm or more and 100 nm or less.

4. The catalyst of claim 1, wherein the catalyst portion includes a plurality of Ir oxide particles stacked in the aggregate based on a direction, perpendicular to the surface of the support particle.

5. The catalyst of claim 1, wherein the Ir oxide particle further includes Ru.

6. The catalyst of claim 5, wherein a molar ratio of Ir to Ru in the Ir oxide particle is 5% to 95%.

7. The catalyst of claim 1, wherein a ratio of the exposed region on the surface of the support particle is 10% to 50%.

8. The catalyst of claim 1, wherein a diameter of the Ir oxide particle is 1 nm to 10 nm.

9. The catalyst of claim 1, wherein the catalyst portion further includes an Ru oxide particle.

10. The catalyst of claim 9, wherein the Ir oxide particle and the Ru oxide particle are randomly mixed.

11. The catalyst of claim 9, wherein the Ir oxide particle and the Ru oxide particle are each formed in a layer structure and are separated from each other.

12. The catalyst of claim 11, wherein the Ru oxide particle is disposed closer to the support particle than the Ir oxide particle.

13. A membrane-electrode assembly comprising:
first and second catalyst electrodes; and
a polymer electrolyte membrane disposed between the first and second catalyst electrodes,
wherein the first catalyst electrode includes a support particle and a catalyst portion formed on a surface of the support particle and including an aggregate of Ir oxide particles, and a portion of the surface of the support particle is an exposed region not covered with the catalyst portion.

14. The membrane-electrode assembly of claim 13, wherein the first catalyst electrode includes a plurality of the support particles, and among the plurality of support particles, the catalyst portions of adjacent support particles are connected to each other.

15. The membrane-electrode assembly of claim 14, wherein the first catalyst electrode includes a pore formed by the exposed region.

16. The membrane-electrode assembly of claim 14, wherein the first catalyst electrode includes a pore formed by the catalyst portions connected to each other.
